(19) United States
(12) Patent Application Publication
(10) Pub. No.: US 2016/0307248 A1
(43) Pub. Date: Oct. 20, 2016

(54) METHOD, SET OF MACHINE READABLE INSTRUCTIONS, AND COMPUTING SYSTEM ADAPTED FOR DETERMINING AN ACCEPTABLE OFFER PRICE FOR A PRODUCT OR SERVICE

(71) Applicants: Erik Harland Payne, Anaheim, CA (US); Sara Kathryn Payne, Anaheim, CA (US); Mark Lynn Koenig, Lake Havasu City, AZ (US); Christopher A. Bailey, Ojai, CA (US)

(72) Inventors: Erik Harland Payne, Anaheim, CA (US); Sara Kathryn Payne, Anaheim, CA (US); Mark Lynn Koenig, Lake Havasu City, AZ (US); Christopher A. Bailey, Ojai, CA (US)

(21) Appl. No.: 15/130,257

(22) Filed: Apr. 15, 2016

Related U.S. Application Data
(60) Provisional application No. 62/147,700, filed on Apr. 15, 2015.

(51) Int. Cl. G06Q 30/06; G06F 3/0481; G06F 3/0484; G06Q 20/10

(52) U.S. Cl. CPC G06Q 30/0611; G06Q 30/0641; G06Q 20/102; G06F 3/04817; G06F 3/04842

(57) ABSTRACT

An example method, set of machine readable instructions stored on a storage device, and computer system, each adapted for determining an acceptable offer price for a product or service are described herein. In the method, a reserve price is set for a desired product or service that is displayed to a user. Upon receiving an offer on the product or service by the user, a given fee may be billed to the user in response thereto. Upon the input of the offer, a determination is made as to whether or not it meets or exceeds the set reserve price. If the offer amount is less than the reserve price, the reserve price is automatically lowered by a given amount, otherwise the offered amount input by the user for the desired product or service is accepted.

### CROSS-REFERENCE TO RELATED APPLICATIONS

The present application claims the benefit under 35 U.S.C. §119(e) of U.S. Provisional Patent Application Ser. No. 62/147,700 to Erik. H. Payne, et al., filed Apr. 15, 2015, pending. The entire contents of this provisional application is hereby incorporated by reference herein.

### BACKGROUND

### Field

The example embodiments in general are directed to a method, a set of machine readable instructions and associated data stored on a storage device, a computer system and a computing device, each adapted determining an acceptable offer price for a product or service.

### SUMMARY

An example embodiment of the present invention is directed to a method of determining an acceptable offer price for a product or service. In the method, a reserve price is set for a desired product or service sold online that is displayed to a user. Upon receiving an indication that the user desires to make an offer on the product or service, a given fee is billed to the user in response to the indication to make an offer. Upon the user inputting the offer, a determination is made as to whether or not it meets or exceeds the set reserve price. If the offer is less than the reserve price, the reserve price is automatically lowered by a given amount, otherwise the offer input by the user for the desired product or service is accepted. The setting, billing, determining, lowering, and accepting functions are performed by computer software adapted to run on computer hardware.

Another example embodiment is directed to a method of determining an acceptable offer price for a product or service, whereby a reserve price is set for a desired product or service sold online that is displayed to a user. Upon receiving an indication that the user desires to make an offer on the product or service, a given fee is billed to the user in response to the indication to make an offer. Upon the user inputting the offer, a determination is made, based on the set reserve price, as to whether the offer is accepted or rejected. The setting, billing, and determining functions are performed by computer software adapted to run on computer hardware.

Another example embodiment is directed to a method of determining an acceptable offer price for a product or service, whereby a reserve price is set for a desired product or service sold online that is displayed to a user, and an offer on the product or service is received from the user. Upon receiving the offer, a determination is made as to whether or not it meets or exceeds the set reserve price. If the offer is less than the reserve price, the reserve price is automatically lowered by a given amount, otherwise the offer input by the user for the desired product or service is accepted. The setting, determining, lowering, and accepting functions are performed by computer software adapted to run on computer hardware.

Another example embodiment is directed to a set of machine readable instructions and associated data stored on a storage device configured so as to determine an acceptable offer for a product or service, the set stored on a storage device in a manner more persistent than a signal in transit. The set may include a price setting module programmed to set a reserve price for a desired product or service sold online that is displayed to a user, and a billing module programmed to bill a given fee to the user in response to an indication that the user desires to make an offer for the desired product or service. The set may further include an analysis module programmed to compare an amount offered by the user to the reserve price, to lower the reserve price by a given amount if the offer is less than the reserve price, otherwise to accept the offer input by the user for the desired product or service.

Another example embodiment is directed to a computer system adapted to determine an acceptable offer for a product or service. The system includes a processing hardware set and a computer readable storage device medium. The processing hardware set is structured, connected and/or programmed to run program instructions stored on the computer readable storage medium instructions and associated data. The program instructions may include a price setting module programmed to set a reserve price for a desired product or service sold online that is displayed to a user, and a billing module programmed to bill a given fee to the user in response to an indication that the user desires to make an offer for the desired product or service. The program instructions may further include an analysis module programmed to compare an amount offered by the user to the reserve price, to lower the reserve price by a given amount if the offer is less than the reserve price, otherwise to accept the offer input by the user for the desired product or service.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a flow diagram to describe in general terms a method adapted for determining an acceptable offer price for a product or service.

FIG. 2 illustrates an exemplary computer system in accordance with some embodiments.

FIG. 3 is a simplified block diagram of an exemplary computing device of some embodiments.

FIG. 4 is a flow diagram to illustrate the make offer step of FIG. 1 in more detail.

FIG. 5 is a flow diagram to illustrate the fee charge step of FIG. 1 in more detail.

FIG. 6 is a flow diagram to illustrate the determining step of FIG. 1 in more detail.

FIG. 7 is a flow diagram to illustrate the lowering of reserve price step of FIG. 1 upon a rejected offer in more detail.

FIG. 8 is a flow diagram to illustrate the offer acceptance step of FIG. 1 in more detail.

FIG. 9 is a screen shot of a product and description page with set reserve price that is displayed to the user in response to a user query for a given product or service, according to the example embodiments.

FIG. 10 is a screen shot of a make offer interface displayed to the user according to the example embodiments.

FIG. 11 is a screen shot of a review and submit offer interface displayed to the user according to the example embodiments.

FIG. 12 is a screen shot of an example offer rejected indication displayed to the user according to the example embodiments.

FIG. 13 is a screen shot of an example offer accepted indication displayed to the user according to the example embodiments.

FIG. 14 is a screen shot of an example shopping cart webpage displayed to the user according to the example embodiments.

FIG. 15 is a screen shot of an example review checkout webpage displayed to the user according to the example embodiments.

### DETAILED DESCRIPTION

As will be appreciated by one skilled in the art, the example embodiments of the present invention may be embodied as a system, method, set of machine readable instructions and associate data in a manner more persistent than a signal in transit, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

In yet another embodiment, the computing system(s), method(s) and computer program product(s) as described in the example embodiments can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of the example embodiments.

Exemplary hardware that can be used for the example embodiments includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus or device, or any suitable combination of the foregoing. A non-exhaustive list of specific examples for a computer-readable storage medium would include at least the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this document, a computer-readable storage medium may be any tangible medium that can contain or store a program for use by or in connection with an instruction execution system, apparatus or device. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Accordingly, the present invention foresees that a non-transitory computer readable information storage media having stored thereon information, that, when executed by a processor, causes the steps described in more detail hereafter in the example method(s) to be performed.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including but not limited to wireless, wireline, optical fiber cable, RF, etc., or any suitable combination of the foregoing.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

Computer program code for carrying out operations for aspects or embodiments of the present invention may be written in any combination of one or more programming languages, including an object oriented programming language such as JAVA®, SQL™ PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider).

Embodiments and aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

As used herein, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, any kind of database object described herein can be implemented as a single database, a distributed database, a collection of distributed databases, a database with redundant online or offline backups or other redundancies, etc., and might include a distributed database or storage network and associated processing intelligence.

As used herein, the phrase “present invention” should not be taken as an absolute indication that the subject matter described by the term “is covered by either the claims as they are filed, or by the claims that may eventually issue after patent prosecution; while the term “present invention” is used to help the reader to get a general feel for which disclosures herein are believed as maybe being new, this understanding, as indicated by use of the term “present invention,” is tentative and provisional and subject to change over the course of patent prosecution as relevant information is developed and as the claims are potentially amended.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

As will be described in more detail hereafter, the example method, non-transitory computer readable information storage media, set of machine readable instructions and associated data stored in a storage device, and computer system are configured to determine an acceptable offer price for a product or service that is made by a user online. Product vendor sources (or “seller sources”) may include any online shopping or retailer website, and also any products from consignment or contractual liquidation sources, or products that are endemic to the servicing website to determine an acceptable offer. Product vendor sources may include but are not limited to social media sources such as networking platforms or websites on which products or services are advertised, including but not limited to FACEBOOK®, TWITTER®, LINKED IN®, MYSPACE®, FRIENDSTER® and TUMBLR®, and the like. Social media sources on which products or services are advertised may also include platforms or websites such as INSTAGRAM®, FLICKR®, PINTEREST® and YOUTUBE.

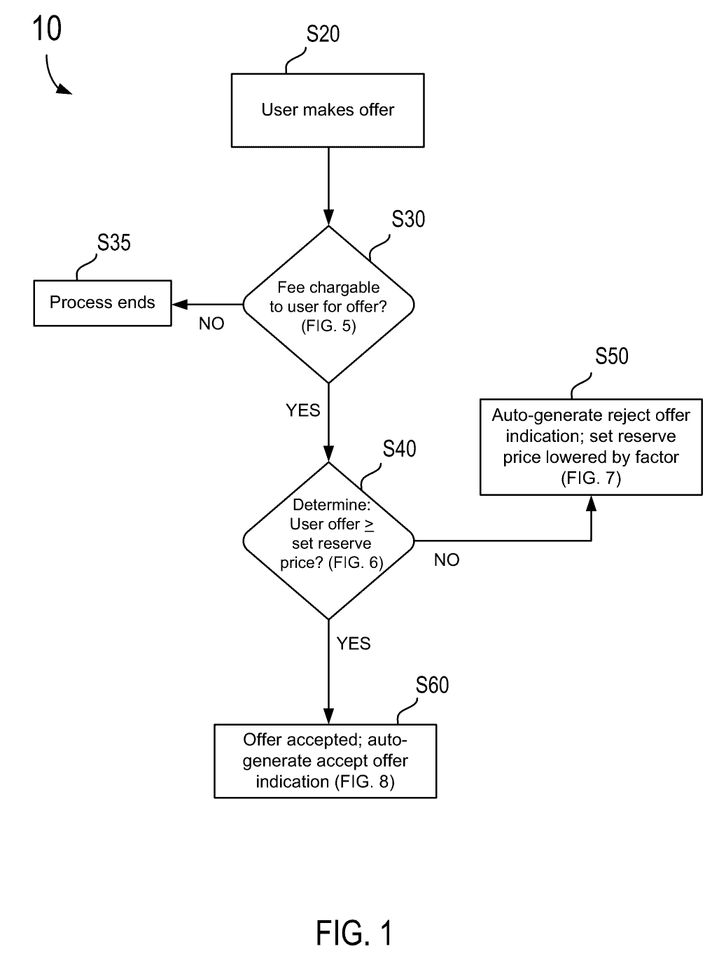

FIG. 1 is a flow diagram to describe in general terms a method 10 adapted for determining an acceptable offer price for a product or service. As shown in FIG. 1, upon a user (who is accessing and employing the example website service) entering a query for a desired product or service sold online and displayed to the user in a suitable display medium, a reserve price for the desired product or service is set (S20) in accordance with the example method by computer software implementing the method by running on computer hardware. The initial set reserve price may in one example be a programmatically adjustable amount, can be manually set or calculated as desired. Upon receiving an indication that the user desires to make an offer on the product or service, the method determines whether or not a given offer fee may be billed (S30) to the user in response to the indication to make an offer. As will be described further below, this may include evaluating a user's account with the website service, particularly as to whether or not sufficient funds exist in the account to debit the offer fee. If it is determined that the user's account has insufficient funds (output of S30 is “NO”), the method 10 terminates. Otherwise the fee is billed (output of S30 is “YES”) and the method 10 proceeds with a determination based on the set reserve price and the offer amount.

At S40, the example method as implemented in software running on hardware determines, upon the user inputting the offer, whether or not it meets or exceeds the set reserve price. The method 10 calculates and adjust the reserve price to a new reserve price of the product/service by lowering the reserve price a given amount, if the offer is less than the reserve price (output of S40 is “NO”) and instantaneously auto-generates a reject offer indication to the user. Otherwise (output of S40 is “YES”), the methodology accepts the offer input by the user for the desired product or service and instantaneously auto-generates an accept offer indication to the user. Additional details of the above steps or functions are described in further detail hereafter.

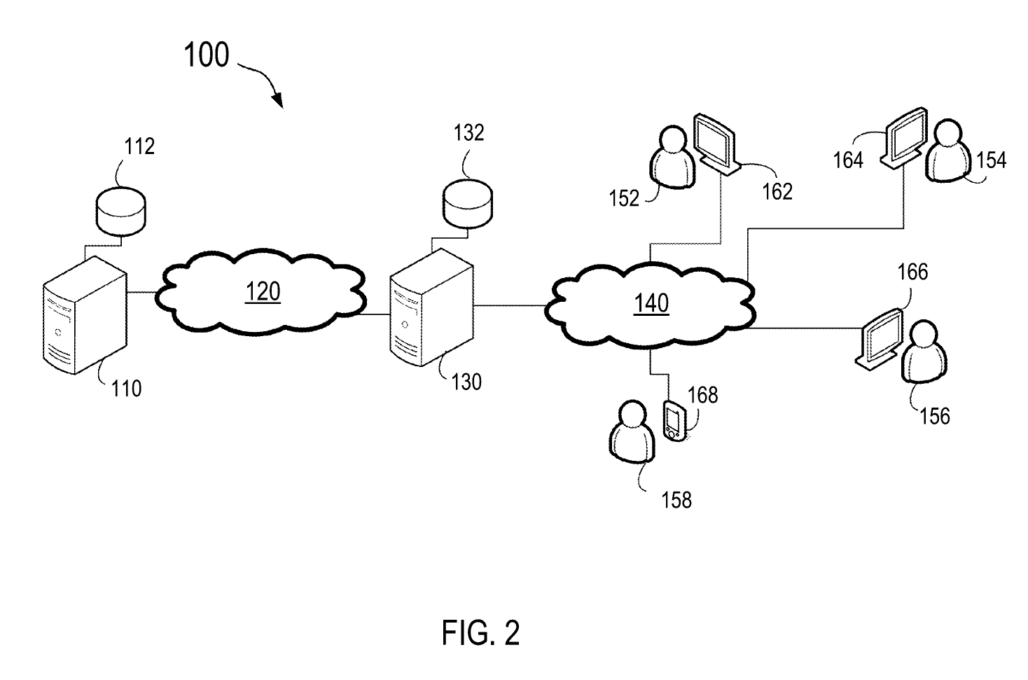

FIG. 2 illustrates an exemplary computer system 100 in accordance with some embodiments for implementing the example method. In this example, at least one website server 110 is operated by a company that provides a website service for determining an acceptable offer for a given product or service so as to form a distributed network. The at least one server 110 communicates with at least one database 112. The at least one database 112 may be configured to store information about users. For example, the at least one database 112 may store user profiles that include a nickname, a real name, an e-mail address, a physical address, a city, a state, a county, and/or a phone number for each user of the website. The at least one database 112 may also store billing/banking and credential data associated with each user of the website. In some embodiments, the at least one database 112 may store reserve price information about given products or services from product vendor websites (e.g., seller sources) that have been extracted by the website upon a query by a user in order to make an offer, as well as offer data associated with the users. In some embodiments, the at least one database 112 may further store historical make offer data from the users as well as past and current product/service description and pricing information extracted from various product vendor websites.

In some embodiments, the at least one database 112 may be included as part of the at least one website server 110. In other embodiments, the at least one database 112 and the at least one website server 110 are separate and communicate over, for example, an intranet or any other suitable network. Embodiments are not limited to any particular website architecture.

If more than one website server 110 is used, they may be located in close proximity to one another (e.g., in a server farm located in a single building or campus), or they may be distributed at locations remote from one another (e.g., one or more servers located in city A and one or more servers located in city B). As used herein, each website server 110 could include one or more logically and/or physically connected servers distributed locally or across one or more geographic locations.

Computer system 100 includes at least one application server 130. Application server 130 communicates with at least one database 132. Database 132 stores profile information for the plurality of users that have stored profiles (user accounts) in the website and make offers on a given product or service. In some embodiments, the at least one database 132 may store reserve price information about given products or services from product vendor websites (e.g., seller sources) that have been extracted by the website upon a query by a user in order to make an offer, as well as offer data associated with the users. In some embodiments, the at least one database 132 may further store historical make offer data from the users as well as past and current product/service description and pricing information extracted from various product vendor websites.

In some embodiments, the at least one database 132 may be included as part of the at least one application server 130. In other embodiments, the at least one database 132 and the at least one application server 130 are separate and communicate over, for example, an intranet or any other suitable network. Embodiments are not limited to any particular server architecture.

In some embodiments, the at least one database 132 may also store historical information about users. For example, if a user's desire for a given product or service is determined based on a portion of the user's past buying history, that may be stored for future use. In this way, in some embodiments, the at least one application server 130 may build a profile for one or more of the users. The profile may include any suitable information about the users. A profile may include, for example, historical purchasing trends of the user (as determined by application server 130), times/dates when needs for given products or services were expressed by the user, geolocation information about the user, and flags that indicate the user is a spammer or some other undesirable type.

The at least one application server 130 receives content from the at least one website server 110 via network 120. Network 120 may be, for example, the Internet and servers 110 and 130 may communicate over network 120 using at least one network interface.

The at least one application server 130 may be configured to analyze the user's account with the website service in order to determine if the offer fee may be billed, and analyzes the received user content to determine whether an offer on a product or service by the user meets or exceeds a criteria to either accept or reject the offer and generate an auto-response to the user. The analysis of the user input may be done in any suitable way; in one example, this may be simply to determine, upon the user inputting the offer, whether or not it meets or exceeds the set reserve price. The reserve price is lowered by a given determined amount if the offer is less than the set reserve price, and an auto-generated response embodied as a reject offer indication is displayed to the user. Otherwise the offer input by the user for the desired product or service is accepted and an auto-generated response embodied as an accept offer indication is displayed to the user.

In some embodiments, in response to determining that an offer is accepted or rejected, a given seller source of the product or service (e.g., the product vendor) may be notified and provided with information about the user. The seller source may be notified in any suitable way. Some embodiments store the notification and user information in database 132 in a manner that is accessible by the seller source. For example, a human 152 associated with the seller source may use a computer 162 to connect to the application server 130 via network 140. The notification and/or information about the potential user/customer may be accessed by the human 152. In other embodiments, a human 158 associated with the seller source may be using a mobile device 168, such as a mobile telephone, tablet, or personal digital assistant (PDA). In some embodiments, the mobile device may be executing a specialized application that gives the human 158 access to the application server 130 in the cloud. The at least one application server 130 may use push notifications to notify the human 158 in real time when a potential customer (user) is identified. In other embodiments, the human 158 may be notified using an SMS message or email message received by mobile device 168.

In some embodiments, a computing device 164 may notify a human 154 associated with the seller source of the offering user in real time by presenting information about the potential customer/user on a display device of the computing device 164. The human 154 associated with the seller source may then respond to the notification by writing and sending a personalized message to the user using computing device 164. By sending the message to the application server 130, information about the message may be stored in database 132 in association with the application software. This may allow tracking of the potential user/customer lead and keep a record of communications with the potential customer for the seller source's records.

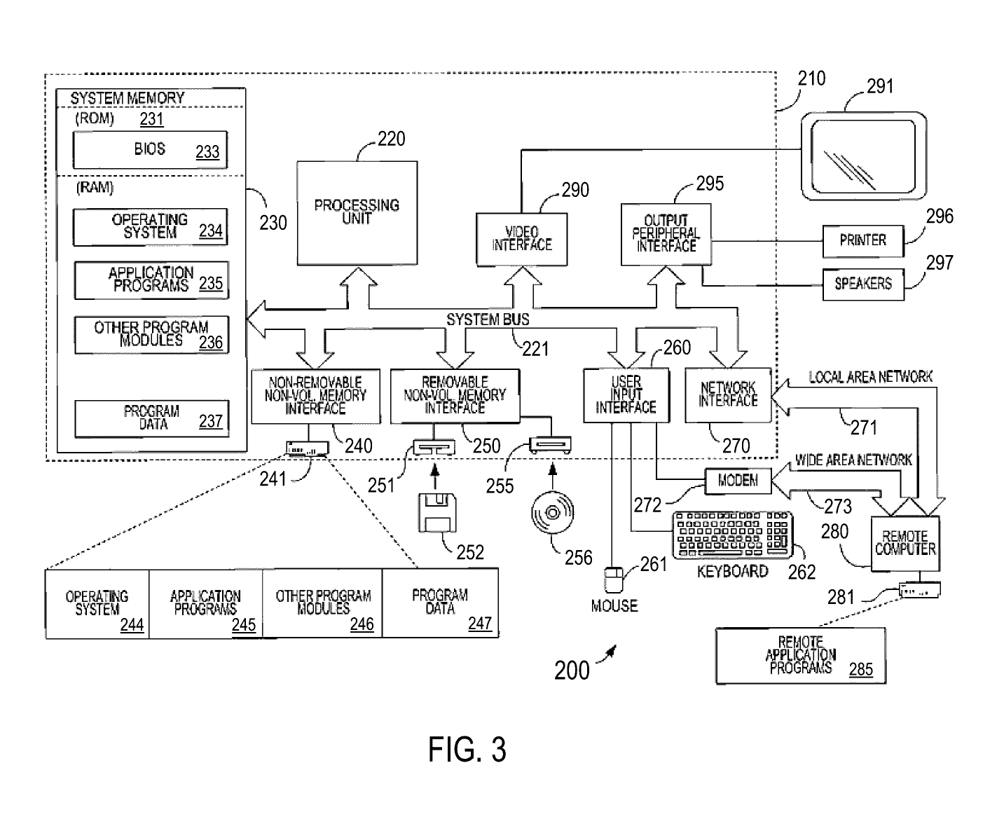

FIG. 3 is a simplified block diagram of an exemplary computing device of some embodiments. With reference to FIG. 3, the exemplary method, non-transitory computer readable information storage media, and set of machine readable instructions and associated data stored in a storage device herein may be implemented by or in a general purpose computing device in the form of a computer 210. Components of computer 210 may include but are not limited to a processing unit 220, a system memory 230, and a system bus 221 that couples various system components including the system memory to the processing unit 220. The processing unit 220 runs computer code run and may be embodied as a central processing unit such as an INTEL® PENTIUM® processor or the like. Similarly, computer 210 and all of its components might be operator-configurable using application(s) including computer code iterated by a central processing unit such as processing unit 220, which may include an INTEL PENTIUM processor or the like, and/or multiple processor units.

The system bus 221 may be any of several types of bus structures including a memory bus or memory controller, a peripheral bus, and a local bus using any of a variety of bus architectures. By way of example and not limitation, such architectures include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnect (PCI) bus also known as a Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EERPOM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 3 illustrates operating system 234, application programs 235, other program modules 236, and program data 237.

The computer 210 may also include other removable/non-removable, volatile/nonvolatile computer storage media. By way of example only, FIG. 3 illustrates a hard disk drive 241 that reads from or writes to non-removable, nonvolatile magnetic media, a magnetic disk drive 221 that reads from or writes to a removable, nonvolatile magnetic disk 222, and an optical disk drive 255 that reads from or writes to a removable, nonvolatile optical disk 226 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 221 and optical disk drive 255 are typically connected to the system bus 221 by a removable memory interface, such as interface 250.

The drives and their associated computer storage media discussed above and illustrated in FIG. 3, provide storage of computer readable instructions, data structures, program modules and other data for the computer 210. In FIG. 3, for example, hard disk drive 241 is illustrated as storing operating system 244, application programs 245, other program modules 246, and program data 247. In one example, the other program modules 246 may include a fetch product/service module programmed to send agents or bots out to product vendor websites (seller sources) in order to extract product/service pictures and descriptions in response to a user search query for a given product or service, and a price setting module programmed to set a reserve price for the desired product or service sold online by the seller sources that is displayed to a user. The other program modules may further include a billing module programmed to bill a given fee to the user in response to an indication that the user desires to make an offer for the desired product or service, and an analysis module programmed to compare an amount offered by the user to the set reserve price, to lower the reserve price by a given amount if the offer is less than the reserve price, otherwise to accept the offer input by the user for the desired product or service. The analysis module may also include functionality to generate an auto-response to the user based on the determination of offer amount to reserve price.

These components may either be the same as or different from operating system 234, application programs 235, other program modules 236, and program data 237. Operating system 244, application programs 245, other program modules 246, and program data 247 are given different numbers here to illustrate that, at a minimum, they are different copies.

Computer 210 may be embodied also as a desktop personal computer, workstation, laptop, PDA, cell phone, or any wireless access protocol (WAP) enabled device or any other computing device capable of interfacing directly or indirectly to the Internet or other network connection. The system may typically run an HTTP client, e.g., a browsing program, such as the INTERNET EXPLORER® browser from MICROSOFT®, FIREFOX® or SAFARI® browsers, or a WAP-enabled browser in the case of a cell phone, PDA or other wireless device, or the like, allowing a subscriber client to access, process and view information, pages and applications available to it from the system over a network, for example. As discussed above, implementations are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 3. The logical connections depicted in FIG. 3 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 3 illustrates remote application programs 285 as residing on memory device 281. It will be appreciated that the network connections shown are exemplary and other means of establishing a communications link between the computers may be used.

It should be appreciated that FIGS. 2 and 3, taken singly or together, provide only one example implementation (that is, system 100 and computer 210) and does not imply any limitations with regard to the environments in which different embodiments may be implemented. Many modifications to the depicted environments may be made, especially with respect to current and anticipated future advances in cloud computing, distributed computing, smaller computing devices, network communications, and the like.

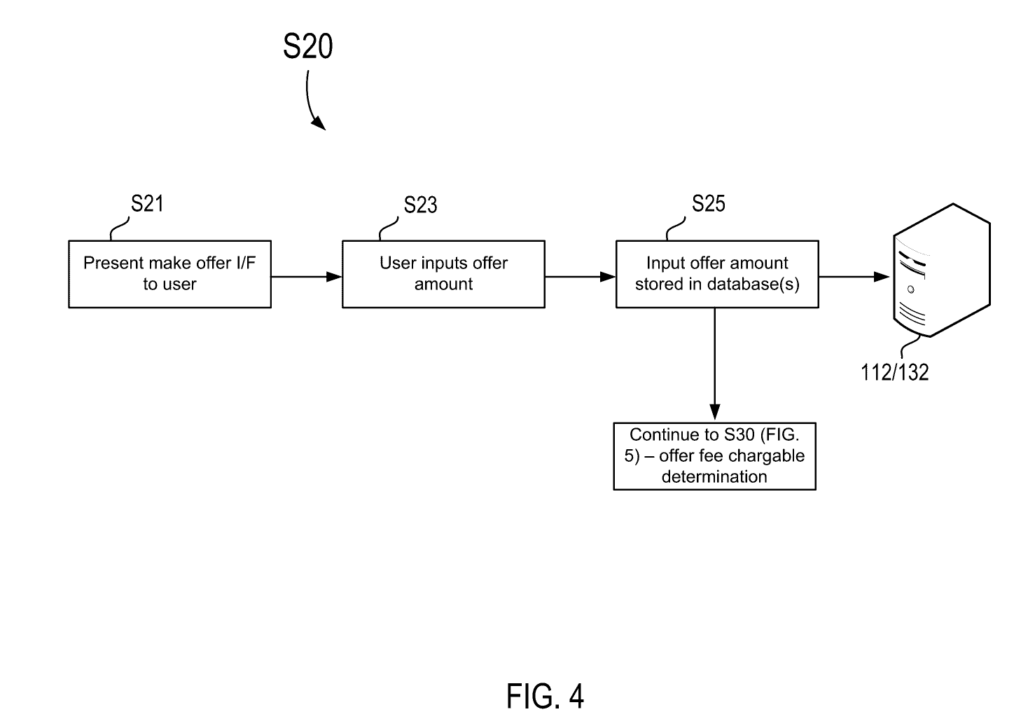

FIG. 4 is a flow diagram to illustrate the make offer step of FIG. 1 in more detail. In order to implement step S20, the method as embodied in software running on computer hardware presents a make offer interface (S21) to the user, so that the user may consider and input an offer for a desired product or service for sale online at the set reserve price and displayed therefor. The user may then input an offer amount (S23) in a suitable data cell on the webpage. This offer is then stored (S25) in at least one database 112 or 132 for example, and the method proceeds to the offer fee determination at S30.

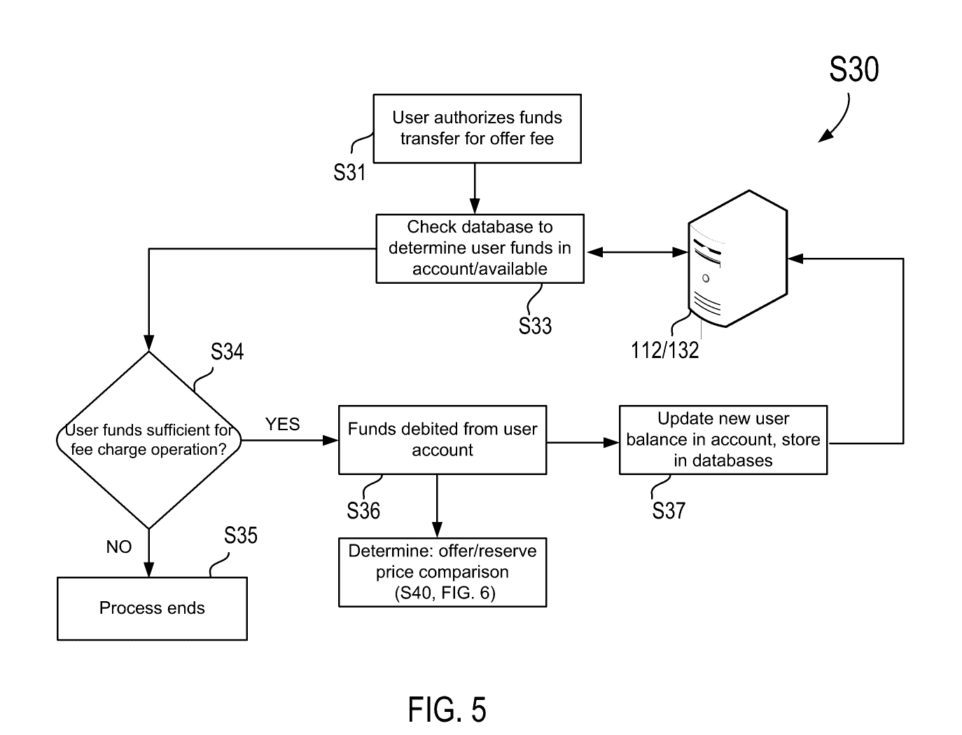

FIG. 5 is a flow diagram to illustrate the fee charge step of FIG. 1 in more detail. Initially, the user, by having an account with the website service, authorizes funds transfer to pay the offer fee (S31). The system software checks the at least one database 112 or 132 to determine whether the user has available funds to debit the fee (S33). If there are insufficient funds (output of S34 is “NO”), the example method 10 terminates; otherwise funds are debited from the user's account (S36) and the new account balance is updated in at least one database 112, 132, with a corresponding indication to the user of the new revised account balance being displayed therefor. The fee having been paid, the method 10 proceeds onward to step S40 to make a determination based on the offer amount as compared to the set reserve price.

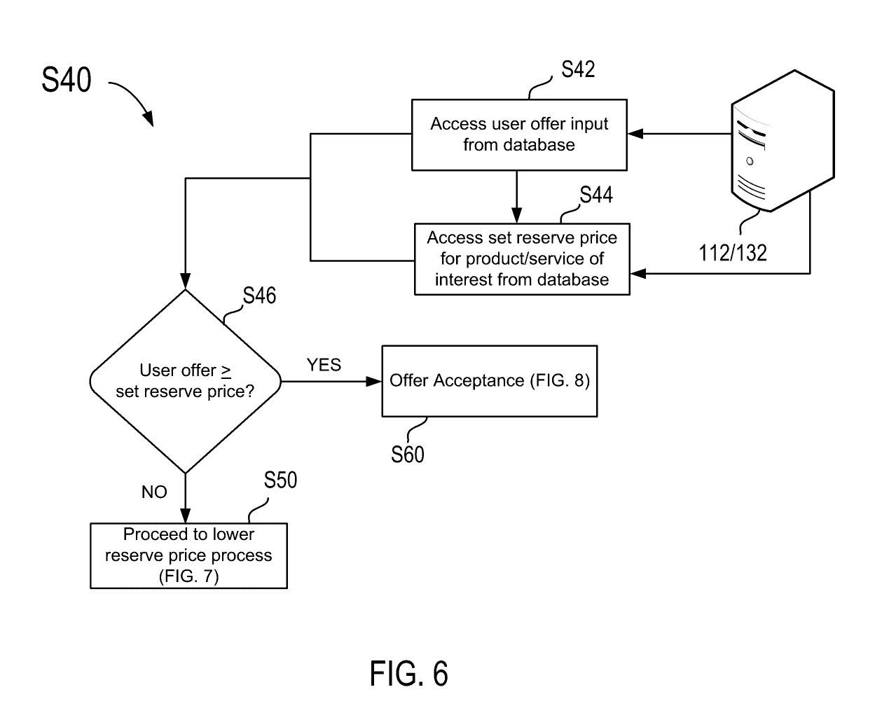

FIG. 6 is a flow diagram to illustrate the determining step of FIG. 1 in more detail. In step S40, the system software access both the user offer (S42) and the set reserve price (S44). An analysis is made as to the amount of the offer as compared to the set reserve price value; namely, if the user offer is less than the set reserve price (“output of S46 is “NO”), the method 10 proceeds to step S50 at which an auto-generated reject offer indication is sent to the user and the set reserve price is lowered by a given determined amount. Otherwise, the offer meets or exceeds the reserve price; in this case it is accepted and an offer acceptance process is implemented at S60.

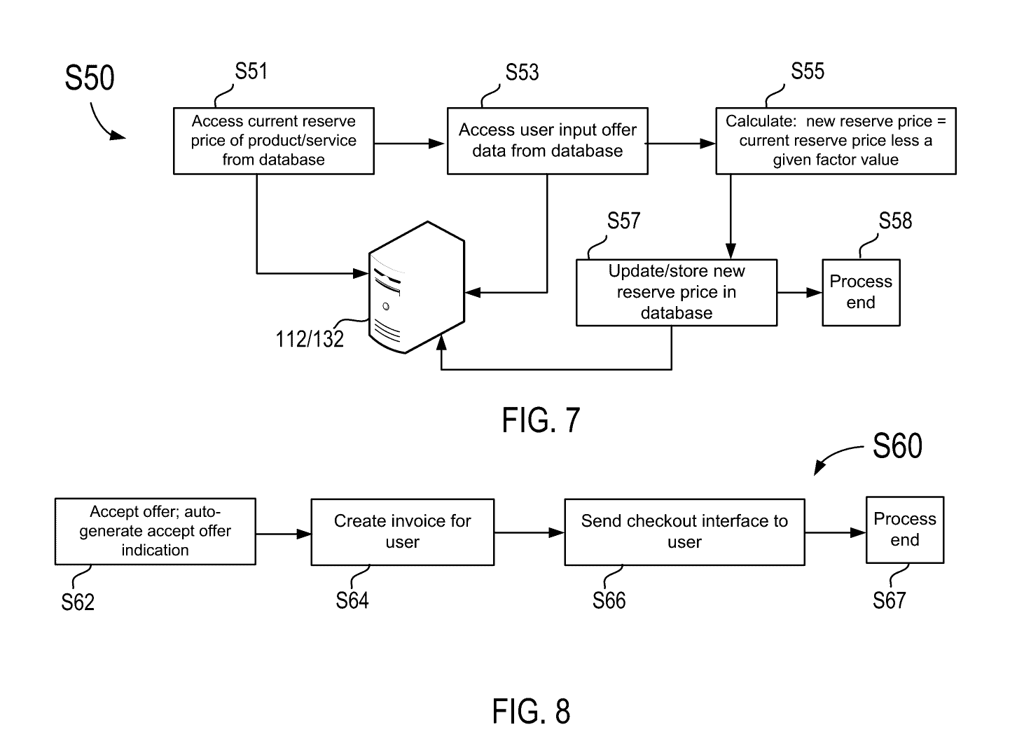

FIG. 7 is a flow diagram to illustrate the lowering of reserve price step of FIG. 1 upon a rejected offer in more detail. As part of step S50, the user instantaneously receives an auto-generated reject offer indication. Simultaneously, a sub-process is iterated to calculate the new reserve price of the product service. For example, the current reserve price (at S51) and user input offer (at S53) are accessed from at least one database 112 or 132, and the new reserve price is calculated based on the current reserve price, the total number of offers made on this product, and a given integer value that is set per offer. Specifically, the new reserve price RP_{new} may be represented by RP_{new}=X−AB, where X represents the current reserve price, A the total number of offers made on that particular product/service of interest, and B a factor or given integer value that is set per offer.

FIG. 8 is a flow diagram to illustrate the offer acceptance step of FIG. 1 in more detail. Where the user's input offer is determined to meet or exceed the reserve price on a desired product or service, the system software accepts the offer and the user instantaneously receives an auto-generated accept offer indication (S62). An invoice is then created for the user (S64) and the user is directed to a pay/checkout webpage by way of the known interface (S66). The method 10 then terminates (S67).

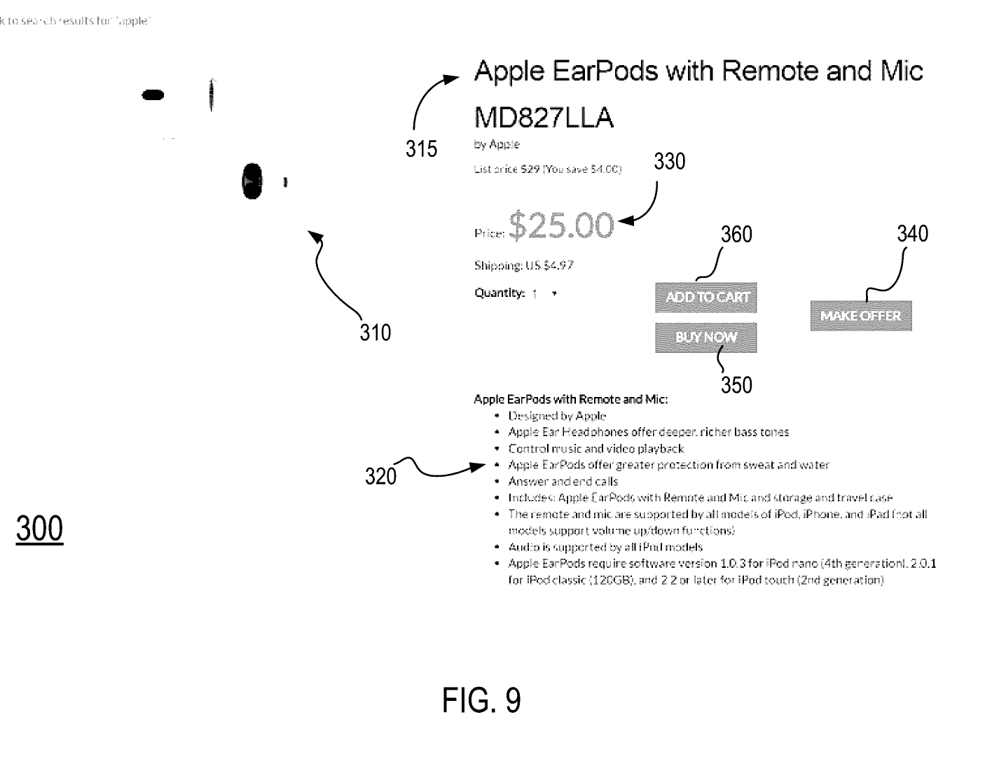

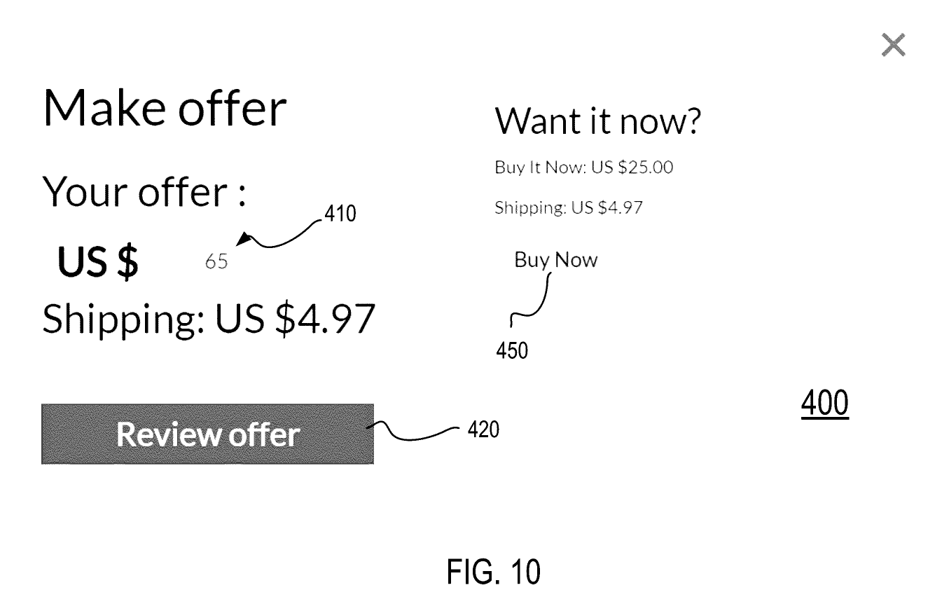

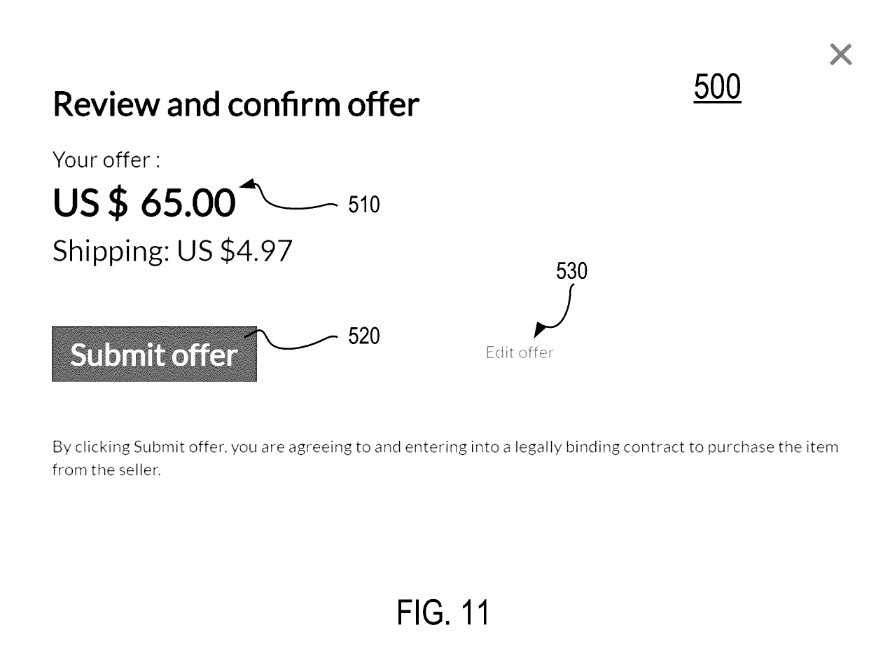

FIG. 9 is a screen shot of a product and description page with set reserve price that is displayed to the user in response to a user query for a given product or service, according to the example embodiments; FIG. 10 a screen shot of a make offer interface displayed to the user; and FIG. 11 a screen shot of a review and submit offer interface displayed to the user according to the example embodiments.

As shown in the screenshot of an example displayed webpage 300 in FIG. 9, upon a user query, a picture or image of the queried product 310, name of the product 315, product description 320 and set initial reserve price 330 may be displayed to the user. Additionally, and if desired, the user may select a radio button 340 to make an offer. Optionally, the webpage may include a selectable radio button 340 to “BUY NOW”, and a radio button 360 to add the product or service to the user's shopping cart.

Upon the user selecting the make offer radio button 340 on webpage 300, another webpage 400 may be displayed. Referring to FIG. 10, the user has access to a data cell 410 to input their offer, a selectable review offer radio button 420, and optionally a BUY NOW radio button 350. Upon actuating review offer radio button 420, the user may be directed to another review and confirm offer webpage 500 as shown in FIG. 11. Here, the input offer 510 is displayed, along with a selectable submit offer radio button 520 and a hypertext link 530 to edit the offer amount, if desired. Actuation of the submit offer radio button 520 automatically initiates steps S30 through S60 as described above.

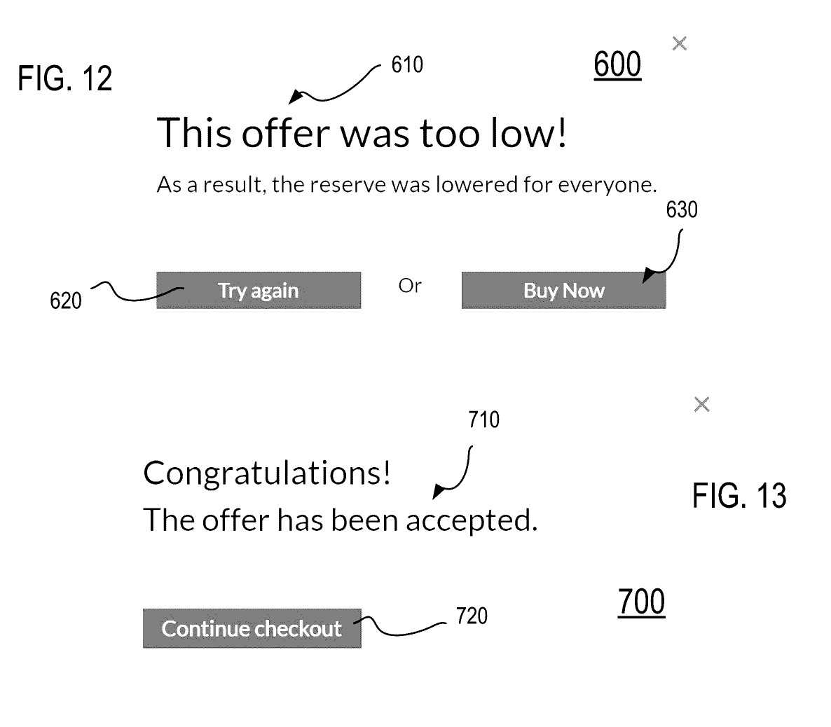

FIG. 12 is a screen shot of an example offer rejected indication displayed to the user, and FIG. 13 a screen shot of an example offer accepted indication displayed to the user according to the example embodiments. Upon actuation of the submit offer radio button 520, on of webpages 600 or 700 is displayed to the user as an auto-generated response. Should the offer not meet the set reserve price, webpage 600 is displayed, with the reject offer indication 610, a try again radio button 620 and optional BUY NOW radio button 630. Otherwise, webpage 700 will be displayed, with accept offer indication 710 and a continue checkout radio button 720, as is known.

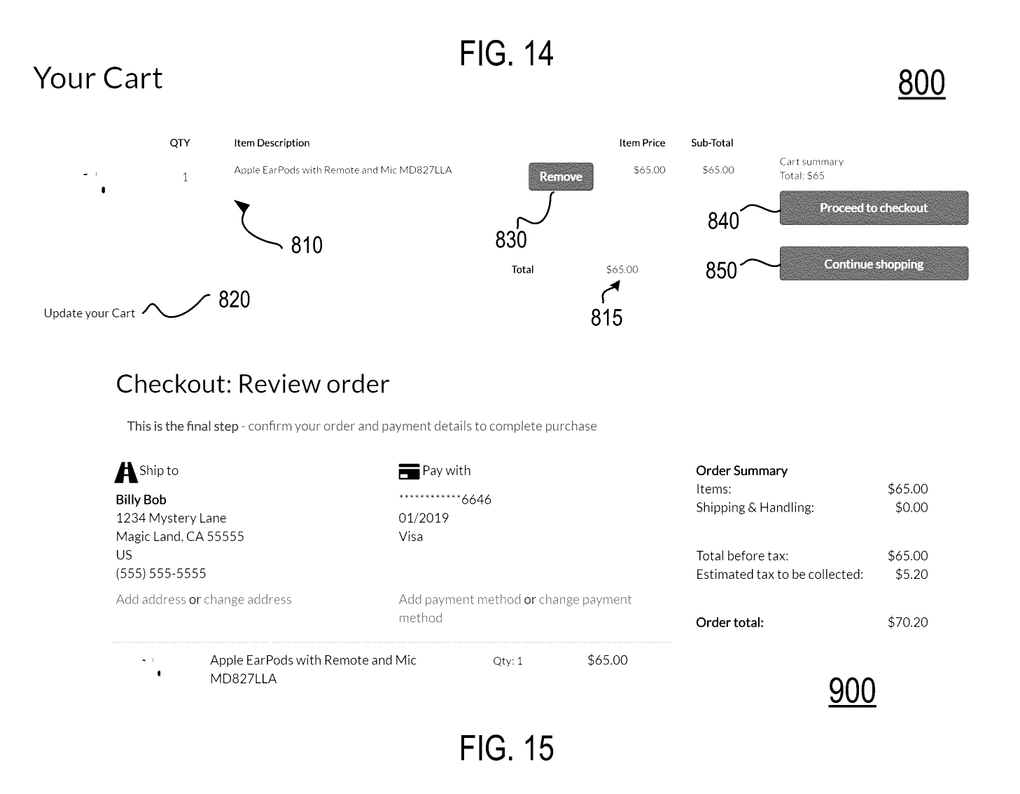

FIG. 14 is a screen shot of an example shopping cart webpage, and FIG. 15 a screen shot of an example review checkout webpage displayed to the user according to the example embodiments. As these features are well known in online shopping forums, a detailed description is omitted for purposes of brevity. The shopping cart webpage 800 may include information such as the product image and description 810, accepted offer price 815, and known update cart, remove, proceed to checkout and continue shopping radio buttons 820, 830, 840 and 850. FIG. 15 merely displays the resultant checkout/review webpage 900, diplayed upon the user deciding to checkout and pay for the product or service.

The present invention, in its various embodiments, configurations, and aspects, includes components, methods, processes, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The flowchart and/or block diagrams in the above-described figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments described herein may be implemented in digital electronic circuitry, or in computer hardware, firmware, software, or in combinations of them. The embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computer system. A computer program can be deployed to be executed on one computer or on multiple computers at one site or distributed across multiple sites and interconnected by a communication network.

Method or function steps of the embodiments described herein can be performed by one or more programmable processors executing a computer program to perform functions of the invention by operating on input data and generating output. Method or function steps can also be performed by, and system and/or apparatus of the invention can be implemented as, special purpose logic circuitry, e.g., an FPGA (field programmable gate array) or an ASIC (application-specific integrated circuit). Modules may refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the embodiments described herein can be implemented on a computer having a display device, e.g., a CRT (cathode ray tube) LED (light emitting diode), or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The embodiments described herein may further be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a LAN and WAN, e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

It is to be understood that the foregoing description is intended to illustrate and not to limit the scope of the invention, which is defined by the scope of the appended claims. Other embodiments are within the scope of the following claims.

We claim:

1. A method for determining an acceptable offer for a product or service, comprising:
setting a reserve price for a desired product or service sold online that is displayed to a user,
receiving an indication that the user desires to make an offer on the product or service,
billing a given fee to the user in response to the indication to make an offer,
determining, upon the user inputting the offer, whether or not it meets or exceeds the set reserve price,
lowering the reserve price by a given amount if the offer is less than the reserve price, otherwise
accepting the offer input by the user for the desired product or service,
wherein the setting, billing, determining, lowering, and accepting steps are performed by computer software adapted to run on computer hardware.

2. The method of claim 1, further comprising:
displaying the product or service, the set reserve price, and a description thereof of the desired product or service to the user.

3. The method of claim 1, further comprising:
displaying a selectable buy now icon to the user.

4. The method of claim 1, further comprising:
displaying an accept offer or a reject offer indication to the user based on the determining step.

5. The method of claim 1, further comprising:
displaying a selectable make offer icon to the user.

6. The method of claim 5, wherein the billing step is executed automatically upon the user selecting the make offer icon, a credentialed account of the user instantaneously billed for the given fee as a cost to make the offer.

7. The method of claim 1, further comprising:
displaying a selectable enter offer amount icon to the user.

8. The method of claim 7, wherein the determining and lowering or accepting steps are instantaneously executed upon the user inputting the enter offer amount.

9. A non-transitory computer readable information storage media having stored thereon information, that when executed by a processor, causes to be performed the steps in claim 1.

10. A method for determining an acceptable offer for a product or service, comprising:
setting a reserve price for a desired product or service sold online that is displayed to a user,
receiving an indication that the user desires to make an offer on the product or service,
billing a given fee to the user in response to the indication to make an offer,
determining, based on the set reserve price, whether the offer is accepted or rejected,
wherein the setting, billing, and determining steps are performed by computer software adapted to run on computer hardware.

11. The method of claim 10, further comprising:
displaying a selectable make offer icon to the user.

12. The method of claim 11, wherein the billing step is executed automatically upon the user selecting the make offer icon, a credentialed account of the user instantaneously billed for the given fee as a cost to make the offer.

13. The method of claim 10, further comprising:
displaying a selectable enter offer amount icon to the user.

14. The method of claim 13, wherein the determining step is instantaneously executed upon the user inputting the enter offer amount.

15. The method of claim 10, further comprising:
displaying the product or service, the set reserve price, and a description thereof of the desired product or service to the user.

16. The method of claim 10, further comprising:
displaying a selectable buy now icon to the user.

17. The method of claim 10, further comprising:
displaying an accept offer or a reject offer indication to the user based on the determining step.

18. A method for determining an acceptable offer for a product or service, comprising:
setting a reserve price for a desired product or service sold online that is displayed to a user,
receiving an offer on the product or service from the user,
determining, upon the user inputting the offer, whether or not it meets or exceeds the set reserve price,
lowering the reserve price by a given amount if the offer is less than the reserve price, otherwise
accepting the offer input by the user for the desired product or service,
wherein the setting, determining, lowering, and accepting steps are performed by computer software adapted to run on computer hardware.

19. The method of claim 18, further comprising:
displaying a selectable enter offer amount icon to the user.

20. The method of claim 19, wherein the determining and lowering or accepting steps are instantaneously executed upon the user inputting the enter offer amount.

21. The method of claim 18, further comprising:
displaying the product or service, the set reserve price, and a description thereof of the desired product or service to the user.

22. The method of claim 18, further comprising:
displaying a selectable buy now icon to the user.

23. The method of claim 18, further comprising:
displaying an accept offer or a reject offer indication to the user based on the determining step.

24. A set of machine readable instructions and associated data configured so as to determine an acceptable offer for a product or service, the set stored on a storage device in a manner more persistent than a signal in transit, the set comprising:
a price setting module programmed to set a reserve price for a desired product or service sold online that is displayed to a user,
a billing module programmed to bill a given fee to the user in response to an indication that the user desires to make an offer for the desired product or service, and
an analysis module programmed to compare an amount offered by the user to the reserve price, to lower the reserve price by a given amount if the offer is less than the reserve price, otherwise to accept the offer input by the user for the desired product or service.

25. A computer system adapted to determine an acceptable offer for a product or service, comprising:
a processing hardware set, and
a computer readable storage device medium, wherein
the processing hardware set is structured, connected and/or programmed to run program instructions stored on the computer readable storage medium instructions and associated data, the program instructions including:
a price setting module programmed to set a reserve price for a desired product or service sold online that is displayed to a user,
a billing module programmed to bill a given fee to the user in response to an indication that the user desires to make an offer for the desired product or service, and
an analysis module programmed to compare an amount offered by the user to the reserve price, to lower the reserve price by a given amount if the offer is less than the reserve price, otherwise to accept the offer input by the user for the desired product or service.
